(19) United States
(12) Patent Application Publication
(10) Pub. No.: US 2011/0205029 A1
(43) Pub. Date: Aug. 25, 2011

(54) SYSTEM FOR RECEIVING DATA FROM AN OBJECT

(76) Inventor: Rita Sanvincenti, Firenze (IT)

(21) Appl. No.: 13/061,662

(22) PCT Filed: Aug. 28, 2009
(86) PCT No.: PCT/EP2009/061119

§ 371 Date: May 4, 2011

(30) Foreign Application Priority Data
Sep. 2, 2008 (IT) MI2008A001570

(51) Int. Cl. G06K 7/01

(52) U.S. Cl. 340/10.1

(57) ABSTRACT

A system for receiving data from an object, whose particularity consists in comprising at least one radio frequency transponder adapted to be connected to an object, said transponder containing information related to the object that one wishes to send to a user, at least one receiving device, adapted to be carried by a user, being adapted to read said at least one transponder and to receive said information sent by said transponder and related to said object.

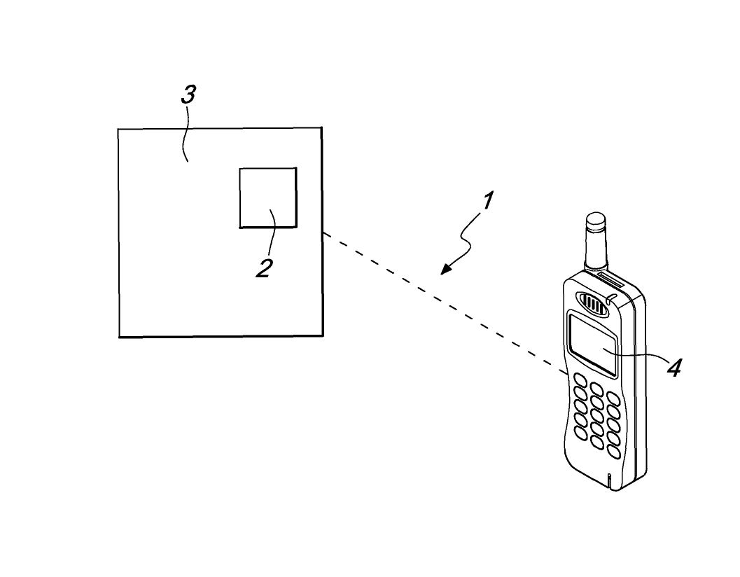

### TECHNICAL FIELD

The present invention relates to a system for receiving data from an object, such as for example a magazine, an item of clothing or any other object of which one wishes to provide related information.

### BACKGROUND ART

More particularly, the invention relates to a system that makes it possible to receive information (data) from an object upon the simple passage of a person within a given radius from the object itself, therefore without contact, so as to provide the interested user with information related to said object.

As is known, for example in the case of magazines, books and the like, there is a large amount of information correlated to articles that are present in the magazine or advertising messages that are usually present within the magazine itself but force the user to open the magazine and read its contents. However, it would be useful, not only in the case of magazines but also in the case of items of clothing, clothing accessories and in any case any object of which one wishes to convey information to possible buyers/users, to be able to transfer such information to the user nearly automatically, upon mere approach of the user to the object itself.

Usually, this information is currently available either by visiting the websites of the corresponding products or by reading, for example as regards items of clothing, the corresponding tags, or also, for example in the case of electronic devices, by reading the instruction booklet.

However, in today's chaotic world, this entails the need for the user to dwell attentively and examine and read the content of an illustration manual or read the content of a magazine, with the risk of sometimes not identifying for example the links that might be interesting for advertising purposes and the like.

It is in fact also important to be able to convey to the user targeted advertising messages, and this of course can be done with difficulty if it is the user who must in any case choose within a magazine where to put his attention and therefore substantially the choice of which message to read is entrusted entirely to the user, who can dwell on one advertisement and instead reject another one.

### DISCLOSURE OF THE INVENTION

The aim of the present invention is to provide a system for receiving data from objects, such as for example items of clothing or objects in paper form such as magazines, books, newspapers and the like, in which the information can be conveyed to the user substantially automatically, without the user having to leaf for example through a magazine or read anything.

Within this aim, an object of the present invention is to provide a system for receiving information from an object that allows the user to receive said information simply by entering within a given radius from said object.

Another object of the present invention is to provide a data reception system that makes it possible, upon reception of said information, to offer the user the possibility to connect to websites that are closely related to the received information.

Another object of the present invention is to provide a system for receiving data from an object that is highly reliable, relatively simple to provide and at competitive costs.

This aim, as well as these and other objects that will become better apparent hereinafter, are achieved by a system for receiving data from an object, characterized in that it comprises at least one radio frequency transponder adapted to be connected to an object, said transponder containing information related to the object that one wishes to send to a user, at least one receiving device, adapted to be carried by a user, being adapted to read said at least one transponder and to receive said information sent by said transponder and related to said object.

### BRIEF DESCRIPTION OF THE DRAWING

Further characteristics and advantages of the invention will become better apparent from the description of a preferred but not exclusive embodiment of the system according to the present invention, illustrated by way of non-limiting example in the accompanying drawing, wherein the only FIGURE is a block diagram of the system according to the present invention.

### WAYS OF CARRYING OUT THE INVENTION

With reference to the figure, the system according to the present invention, generally designated by the reference numeral 1, comprises at least one radio frequency transponder or “tag” 2, which is adapted to be connected to an object, such as for example an item of clothing or any other object, or an object in the form of paper-like material, such as a magazine or the like, designated by the reference numeral 3.

The example of the magazine will be discussed hereinafter as a significant example, but of course anything that is described in relation to such example can be applied likewise to any other object.

The at least one tag 2 contains, written therein, information related to the object and therefore, for example in the case of a magazine, it can be possible for example to enter the content of the magazine, links to websites that can be correlated to the magazine, or adverts that can be sent in a targeted manner to the user, or links to advertising sites, or links to sites that can offer discounts in connection with the purchase of the magazine and the like.

Substantially, the data written in the at least one tag 2 are adapted to be sent and received by a receiving device 4 adapted to read radio frequency tags.

Conveniently, the receiving device 4 can be a cellular device with Bluetooth or the like.

Substantially, therefore, when the user who owns the data receiving device 4 enters the appropriate radius from the tag 2 applied to the object 3, he can receive, directly on his receiving device 4, such as a mobile phone or the like, the information contained in the tag, and connect, for example in the case of mobile phones enabled for Internet navigation, directly to the links that can be sent by the tag to the receiving device 4.

Conveniently, the tag 2 can be applied to any part of the object and it can also be provided with particular shapes so as to become an ornamental element of the object itself, so that one is not forced to conceal it within the object itself.

Substantially, the system according to the invention makes it possible to convey to the user information that is related to an object without the user necessarily having to come into contact with the object or, even more so, for example in the case of magazines and the like, having to leaf through the magazine.

In practice it has been found that the system according to the invention fully achieves the intended aim and objects.

The system thus conceived is susceptible of numerous modifications and variations, all of which are within the scope of the appended claims; all the details may further be replaced with other technically equivalent elements.

The disclosures in Italian Patent Application No. MI2008A001570 from which this application claims priority are incorporated herein by reference.

1-5. (canceled)

6. A system for receiving data from an object, comprising at least one radio frequency transponder adapted to be connected to an object, said transponder containing information related to the object that one wishes to send to a user, at least one receiving device, adapted to be carried by a user, being adapted to read said at least one transponder and to receive said information sent by said transponder and related to said object.

7. The system according to claim 6, wherein said at least one transponder contains information related to said object, links to web pages of interest, advertising messages and the like.

8. The system according to claim 6, wherein said at least one receiving device is a cellular telephone adapted to read said at least one transponder.

9. The system according to claim 6, wherein said object is a magazine.

10. The system according to claim 6, wherein said object is an item of clothing.
